(19) United States
(12) Patent Application Publication
(10) Pub. No.: US 2005/0254699 A1
(43) Pub. Date: Nov. 17, 2005

(54) Apparatus and method for detecting defect and apparatus and method for extracting wire area

(75) Inventors: Hiroshi Sano, Kyoto (JP); Eiji Nishihara, Kyoto (JP); Yasushi Nagata, Kyoto (JP); Atsushi Imamura, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG, CO., LTD.

(21) Appl. No.: 11/079,659

(22) Filed: Mar. 15, 2005

(30) Foreign Application Priority Data
May 13, 2004 (JP) P2004-143794

(51) Int. Cl. G06K 9/00

(52) U.S. Cl. 382/149

(57) ABSTRACT

In a reference binary image representing a pattern including wires formed on a substrate, an erosion is performed on a specific area having the same pixel value as a pixel value corresponding to a wire area to acquire an eroded image and a dilation is performed on the specific area which remains in the eroded image to almost the same degree as the erosion to acquire an eroded and dilated image. Subsequently, a differential image between the eroded and dilated image and the reference binary image is generated as a wire image representing a wire area. It is thereby possible to easily extract a wire area which is a fine pattern area. By setting respective different defect detection sensitivities for the wire area and the other area on the basis of the wire image and detecting a defect in an inspection image in accordance with the defect detection sensitivities, it is possible to appropriately detect a defect in a pattern on a substrate.

### BACKGROUND OF THE INVENTION

1. Field of the Invention

The present invention relates to a technique for extracting a specific area from an image representing a geometric pattern including wires (traces) formed on a substrate and a technique for detecting a defect in a pattern by using this extraction technique.

2. Description of the Background Art

In a field of inspecting a pattern including wires (traces) formed on a printed circuit board, a semiconductor substrate, a glass substrate or the like (hereinafter, referred to as “substrate”), a variety of inspection methods have been conventionally used. Japanese Patent Application Laid Open Gazette No. 2002-372502 (Document 1), for example, discloses a technique where an inspection image is divided into a plurality of divided areas and if a divided area includes a plurality of circuit elements, the defect detection sensitivity for the divided area is set higher.

Japanese Patent Application Laid Open Gazette No. 2002-259967 (Document 2) discloses a technique where in a predetermined color space, angle indices in accordance with angles between individual color vectors representing colors of pixels in a color image to be divided and respective representative color vectors of a plurality of representative colors which are set and distance indices in accordance with distances between the colors of the pixels in the image and the respective representative colors are obtained, and the pixels in the image are grouped into a plurality of representative colors in accordance with composite distance indices based on the angle indices and the distance indices, to thereby divide the color image.

In the technique of Document 1, even if there is a fine pattern in only part of a divided area, a high defect detection sensitivity is set for the whole area and this often causes misdetection where even a very small defect which does not need to be detected is determined as a defect. When one pixel is assumed to be one divided area, even if the defect detection sensitivity for a divided area having no wire area is set in accordance with fineness of its closest wire area as disclosed in Document 1, when the divided area and the closest wire area are located away from each other at a certain distance or more, an unnecessarily high defect detection sensitivity is sometimes set. On the other hand, in some cases, depending on patterns, particularly high defect detection sensitivity should be set for an area surrounding wires.

### SUMMARY OF THE INVENTION

The present invention is intended for a defect detection apparatus for detecting a defect in a geometric pattern formed on a substrate. According to a preferable aspect of the present invention, the apparatus comprises an image pickup part for picking up an image of a substrate, an erosion and dilation part for performing an erosion on a specific area having a specific pixel value in one image of an inspection binary image on the basis of an inspection image acquired by the image pickup part and a reference binary image to acquire an eroded image and performing a dilation on the specific area which remains in the eroded image to almost the same degree as the erosion to acquire an eroded and dilated image, a fine pattern area acquisition part for generating a differential image between the eroded and dilated image and the one image as a fine pattern image representing a fine pattern area, a detection sensitivity setting part for setting respective different defect detection sensitivities for the fine pattern area and other area, and a defect detection part for detecting a defect in the inspection image in accordance with the defect detection sensitivities.

In the defect detection apparatus of the present invention, a fine pattern area can be easily extracted, and since the defect detection sensitivity for the fine pattern is set different from that for other area, it is possible to appropriately detect a defect in a pattern on a substrate.

For defect detection with high degree of accuracy, the defect detection apparatus of the present invention further comprises a specific fine pattern area extraction part for acquiring a specific fine pattern area which is used in the detection sensitivity setting part by generating a differential image between two fine pattern images which are generated with the degree of erosion and dilation changed in the erosion and dilation part and the fine pattern area acquisition part.

Preferably, the one image is the inspection binary image, and the fine pattern area acquisition part corrects the fine pattern image by masking the fine pattern image with the reference binary image after the dilation. By generating the fine pattern image from the inspection binary image, it is possible to achieve a defect detection in consideration of a positional difference in a pattern. By using the reference binary image, it is further possible to remove a noise caused by the inspection binary image.

The present invention is also intended for an apparatus for extracting a wire area from an image of a substrate, which uses the function of the defect detection apparatus for generating a fine pattern image.

According to another preferable aspect of the present invention, the defect detection apparatus comprises an image pickup part for picking up an image of a substrate, a dilation part for performing a dilation on a specific area having a specific pixel value in one image of an inspection binary image on the basis of an inspection image acquired by the image pickup part and a reference binary image to acquire a dilated image, a surrounding area acquisition part for generating a differential image between the dilated image and the one image as a surrounding area image representing a surrounding area of the specific area, a detection sensitivity setting part for setting respective different defect detection sensitivities for the surrounding area and the other area, and a defect detection part for detecting a defect in the inspection image in accordance with the defect detection sensitivities.

In this defect detection apparatus of the present invention, a surrounding area can be easily extracted, and since the defect detection sensitivity for the surrounding area is set different from that for other area, it is possible to appropriately detect a defect in a pattern on a substrate.

Preferably, the one image is the inspection binary image, and the surrounding area acquisition part corrects the surrounding area image by masking the surrounding area image with the reference binary image after the dilation. It is thereby possible to achieve a defect detection in consideration of a positional difference in a pattern, and by using the reference binary image, it is further possible to remove a noise caused by the inspection binary image.

Preferably, the substrate is a wiring board and the specific area is an area in the inspection binary image which has the same pixel value as a pixel value corresponding to a wire area. For defect detection with high degree of accuracy, the defect detection apparatus of the present invention further comprises an erosion and dilation part for performing an erosion on a background area having a pixel value corresponding to a background in one image of the inspection binary image and the reference binary image to acquire an eroded image and performing a dilation on the background area which remains in the eroded image to almost the same degree as the erosion to acquire an eroded and dilated image, and a fine background area acquisition part for generating a differential image between the eroded and dilated image and the one image as a fine background image representing a fine background area to separate the fine background area from the surrounding area, and in the defect detection apparatus, the detection sensitivity setting part sets a defect detection sensitivity for the fine background area which is different from that for the surrounding area.

It is thereby possible to detect a defect, with the fine background area separated from the surrounding area, with high degree of accuracy.

The present invention is further intended for a defect detection method for detecting a defect in a geometric pattern formed on a substrate and a wire area extraction method for extracting a wire area from an object image representing a geometric pattern including wires formed on a substrate.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a construction of a defect detection apparatus;

FIG. 2 is a flowchart showing an operation flow for detecting a defect;

FIG. 3 is a view showing an inspection area on a substrate;

FIG. 4 is a view showing a reference binary image;

FIG. 5 is a view showing an eroded image;

FIG. 6 is a view showing an eroded and dilated image;

FIG. 7 is a view showing another eroded and dilated image;

FIG. 8 is a view showing a wire image;

FIG. 9 is a view showing a wire image after a dilation;

FIG. 10 is a flowchart showing an operation flow for detecting a defect;

FIG. 11 is a view showing a wire image;

FIG. 12 is a view showing a wire image representing a wire area having a specific width;

FIG. 13 is a view showing an inspection binary image;

FIG. 14 is a view showing a wire image;

FIG. 15 is a view showing a wire image after being corrected;

FIG. 16 is a view showing part of constitution of a defect detection apparatus in accordance with a second preferred embodiment;

FIG. 17 is a flowchart showing an operation flow for detecting a defect;

FIG. 18 is a view showing a dilated image; and

FIG. 19 is a view showing a surrounding area image.

### DESCRIPTION OF THE PREFERRED EMBODIMENTS

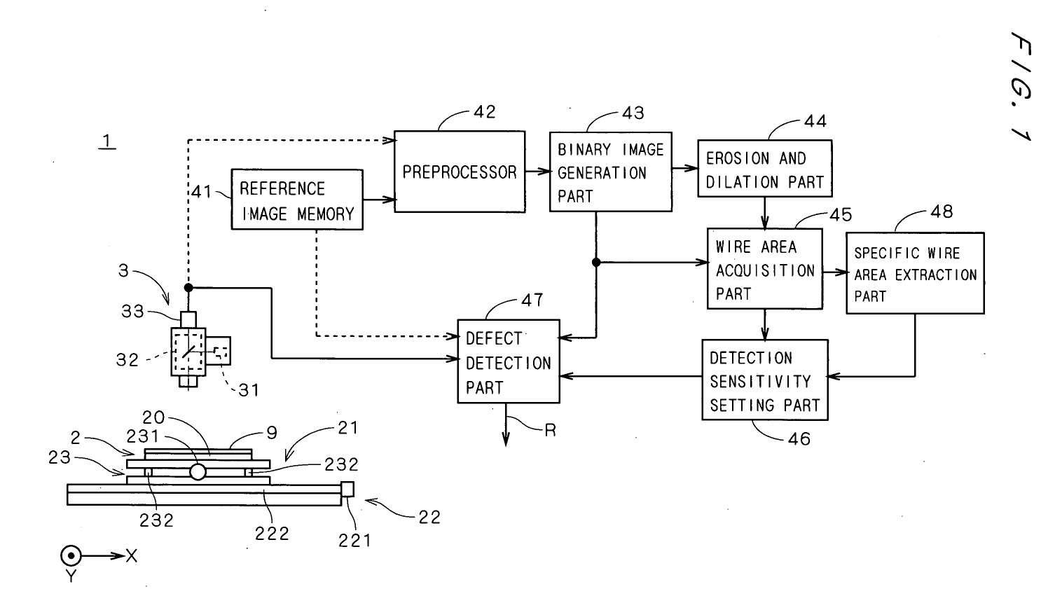

FIG. 1 is a view showing a construction of a defect detection apparatus 1 in accordance with the first preferred embodiment of the present invention. The defect detection apparatus 1 comprises a stage part 2 for holding a printed circuit board on which a pattern including wires (traces) is formed (hereinafter, referred to as “substrate”) 9, an image pickup part 3 for picking up an image of the substrate 9 to acquire a color image of the substrate 9 for inspection and a stage driving part 21 for moving the stage part 2 relatively to the image pickup part 3.

The stage part 2 has a transmitting illumination part 20 for emitting white light towards a lower main surface of the substrate 9 which is the opposite side of an upper surface facing the image pickup part 3. The image pickup part 3 has a lighting part 31 for emitting illumination light, an optical system 32 for guiding the illumination light to the substrate 9 and receiving light from the substrate 9 and an image pickup device 33 for converting an image of the substrate 9 formed by the optical system 32 into an electrical signal. The image pickup device 33 outputs data of inspection color image. The stage driving part 21 has an X-direction moving mechanism 22 for moving the stage part 2 in the X direction of FIG. 1 and a Y-direction moving mechanism 23 for moving the stage part 2 in the Y direction. The X-direction moving mechanism 22 has a motor 221 to which a ball screw (not shown) is connected and with rotation of the motor 221, the Y-direction moving mechanism 23 moves along guide rails 222 in the X direction of FIG. 1. The Y-direction moving mechanism 23 has the same structure as the X-direction moving mechanism 22 has, and with rotation of a motor 231, the stage part 2 is moved along guide rails 232 in the Y direction of FIG. 1 by a ball screw (not shown).

The defect detection apparatus 1 further comprises a reference image memory 41 for storing a reference color image prepared in advance and a preprocessor 42 for acquiring specific areas in the reference color image which correspond to specific portions on the substrate 9, such as a resist area and a through hole area as discussed later, a binary image generation part 43 for binarizing the reference color image to generate a reference binary image, an erosion and dilation part 44 for eroding an area having a specific pixel value in the reference binary image and then dilating the area to acquire an eroded and dilated image, a wire area acquisition part 45 for generating a wire image by extraction of areas which correspond to wires on the substrate 9, a detection sensitivity setting part 46 for setting a defect detection sensitivity on the basis of the wire image and a defect detection part 47 for detecting a defect on the substrate 9 in accordance with the defect detection sensitivity which is set. FIG. 1 shows a specific wire area extraction part 48 connected to the wire area acquisition part 45, but the specific wire area extraction part 48 is used in another operation of the defect detection apparatus 1 discussed later.

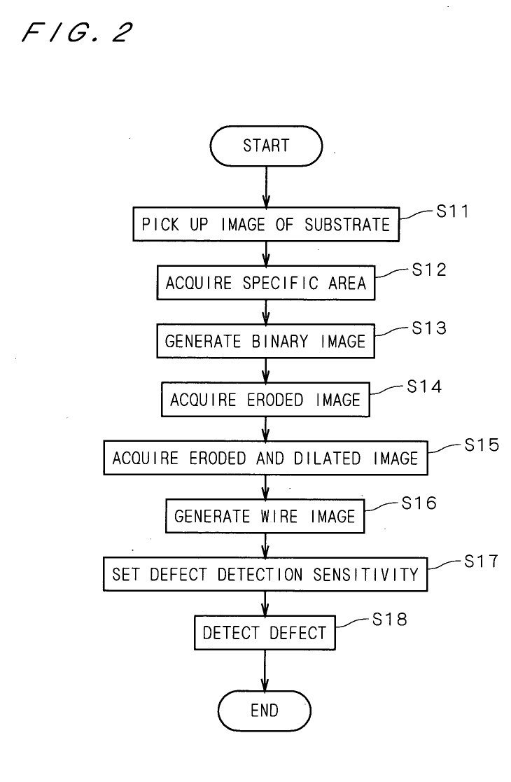

FIG. 2 is a flowchart showing an operation flow of the defect detection apparatus 1 for detecting a defect(s) in a pattern formed on the substrate 9. In the defect detection apparatus 1, first, the substrate 9 is moved by the stage driving part 21 to set a predetermined inspection area on the substrate 9 to an image pickup position for the image pickup part 3 and an image of the substrate 9 is picked up (Step S11).

FIG. 3 is a view illustrating an inspection area 90 on the substrate 9. On the substrate 9 provided are a conductive base 91 from which wires 92 and 93 having different widths are drawn, through holes 94 penetrating the substrate 9, land portions 95 around the through holes 94 and an electrode 96 connected to a wire 92a out of a plurality of fine wires 92. The conductive base 91, the wires 92 and 93, the land portions 95 and the electrode 96 (hereinafter, referred to generally as “conductive portions”) are formed of, e.g., conductive material such as copper, and the wire 92a and the electrode 96 are plated with gold as necessary.

On the substrate 9, an area other than the area represented by reference numeral 81 in FIG. 3 (including the electrode 96 and the wire 92a) is coated with a resist serving as an insulating film. In the area coated with the resist, the conductive portions and a background portion representing the surface of the substrate 9 are green of different brightness in color. In the area without resist, the conductive portions and the background portion are brown of different brightness in color. Thus, on the substrate 9 formed is a geometric pattern including the wires 92 and 93, and the image pickup part 3 acquires pixel values in an inspection color image representing the inspection area 90 and sequentially outputs the pixel values to the defect detection part 47. In an actual inspection color image, each area which corresponds to the through hole 94 is bright white in color with light from the transmitting illumination part 20.

On the other hand, a plurality of following procedures are performed in parallel with Step S11. The following procedures are performed, actually, by a dedicated electric circuit for each several lines in an image to be processed, but for easy understanding, discussion will be made herein assuming that the procedures are performed on the whole image.

In parallel with image pickup of the substrate 9 by the image pickup part 3, the reference color image representing the same pattern as the inspection area 90 shown in FIG. 3 (for example, an image acquired immediately before by picking up an image of the other area in which the same pattern as the inspection area 90 whose image is being picked up) is outputted from the reference image memory 41 to the preprocessor 42, to thereby acquire an area which is specified in advance from the reference color image (Step S12).

As one exemplary procedure of the preprocessor 42, for example, a technique disclosed in the above-discussed Document 2 (Japanese Patent Application Laid Open Gazette No. 2002-259967) can be used, and the disclosure of which is herein incorporated by reference. Specifically, in the reference color image, three respective representative colors representing the area coated with the resist (except the through holes 94), the area without resist and portions for the through holes 94 on the substrate 9 are set in advance by an operator, and in a predetermined color space, angle indices in accordance with angles between individual color vectors representing colors of pixels in the reference color image and respective representative color vectors are obtained.

Subsequently, in the color space, distance indices in accordance with distances between the colors of the pixels in the reference color image and the respective representative colors are obtained, and composite distance indices for the respective representative colors are calculated on the basis of the angle indices and the distance indices. Then, in accordance with the composite distance indices, one of the three areas corresponding to the area coated with the resist, the area without resist and the through holes 94 is determined to which each pixel in the reference color image belongs. Thus, the preprocessor 42 acquires a resist area corresponding to the area on the substrate 9 which is coated with the resist, a non-resist area corresponding to the area without resist and through hole areas corresponding to the through holes 94 from the reference color image and outputs the reference color image and information indicating various areas (hereinafter, referred to as “area information”) to the binary image generation part 43. In the preprocessor 42, if possible, a plurality of areas corresponding to each of the conductive portions and the background portion may be acquired, and the specific area may be acquired by performing the binarization on the reference color image a plurality of times with different threshold values.

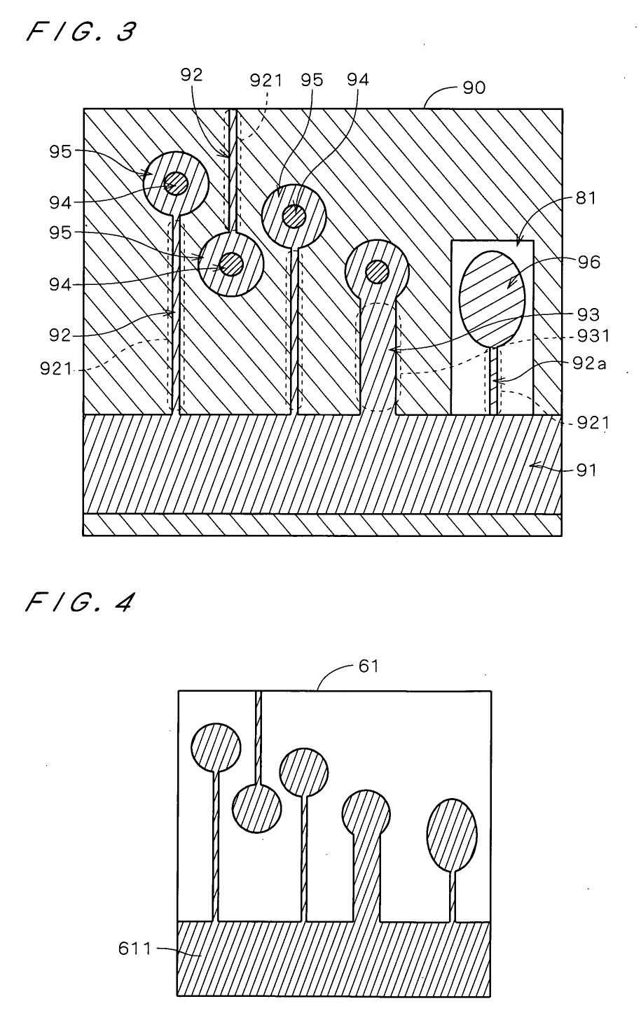

The binary image generation part 43 acquires a color image representing only the resist area (including the through hole areas) and a color image representing only the non-resist area from the reference color image with the area information. Then, the color images are binarized with different threshold values, and for example, two binary images are generated, for example, where the pixel value “1” is given to a conductive area corresponding to the conductive portion on the substrate 9 and the pixel value “0” is given to a background area corresponding to the background portion (Step S13). At this time, the pixel value “1” is forcedly given to the through hole area, and a binary image representing only the resist area and a binary image representing only the non-resist area are each outputted to the erosion and dilation part 44 as the reference binary images. In the following discussion, the binary image representing only the resist area and the binary image representing only the non-resist area are united as one reference binary image 61 to be used, as shown in FIG. 4.

The erosion and dilation part 44 performs an erosion on areas 611 in the reference binary image 61 having the pixel value “1” (which is hatched in FIG. 4, and hereinafter, referred to as “specific area”) to a predetermined degree (the degree of erosion is e.g., the number of repeats when the erosion is repeated with a certain parameter for changing the erosion level, or a parameter when the parameter to be used for the erosion is changed), to thereby acquire an eroded image 62 shown in FIG. 5 (Step S14). At this time, in the eroded image 62, areas in the specific areas 611 which correspond to the fine wires 92 on the substrate 9 (see FIG. 3) disappear and an area in the specific areas 611 which corresponds to the wire 93 remains. The degree of erosion is determined in advance in accordance with the width of the wire on the substrate 9 to be extracted (in other words, the width of the wire to be left in the eroded image 62).

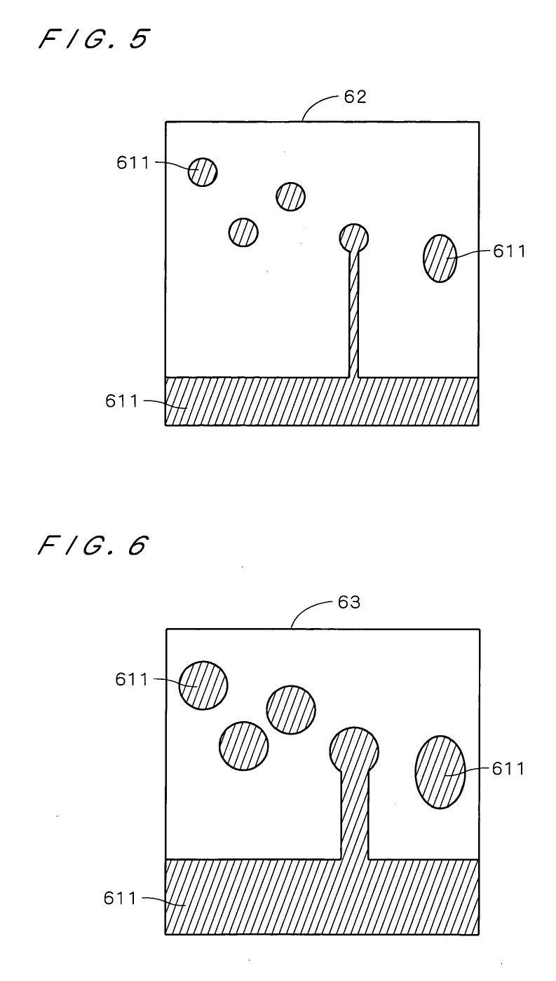

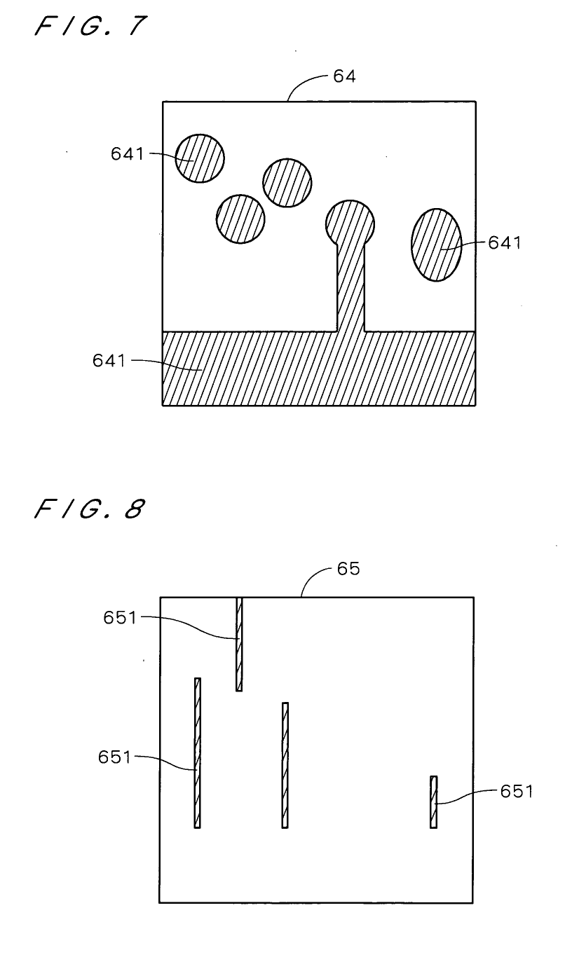

Subsequently, a dilation is performed on the specific areas 611 which remain in the eroded image 62 to almost the same degree as the erosion in the Step S14 (the degree of dilation may be slightly larger than that of erosion), to thereby acquire an eroded and dilated image 63 shown in FIG. 6 (Step S15). Then, the logical product of a value of each pixel in the eroded and dilated image 63 and a value of the corresponding pixel in the reference color image 61 is obtained by calculation, and a new eroded and dilated image 64 having pixel values which are the calculation results is generated as shown in FIG. 7. In the eroded and dilated image 64 of FIG. 7, areas 641 are present, where the area corresponding to the fine wires 92 on the substrate 9 are removed from the specific areas 611 in the reference binary image 61 of FIG. 4 (hereinafter, referred to as “fine wire removed area”).

The new eroded and dilated image 64 is outputted to the wire area acquisition part 45, and the wire area acquisition part 45 obtains the exclusive OR of a value of each pixel in the eroded and dilated image 64 and a value of the corresponding pixel in the reference binary image 61 by calculation, to thereby generate a differential image 65 shown in FIG. 8 (Step S16). Herein, the differential image 65 of FIG. 8 is an image representing a plurality of fine wire areas 651 which correspond to a plurality of fine wires 92 on the substrate 9 having a width smaller than a predetermined value and hereafter referred to as a wire image 65.

At this time, since the binary image generation part 43 gives the through hole area the same pixel value as that given to the conductive area, the wire area acquisition part 45 substantially regards the area which corresponds to the land portion 95 for the through hole and the through hole 94 on the substrate 9 as a non-wire area and this prevents such a case where when the through hole 94 is formed on the substrate 9 with its position being different, the width of part of the land portion 95 is made narrower and the area which corresponds to the part of the land portion 95 appears in the wire image. It is thereby possible to acquire the wire area 651 which is a fine pattern area with high accuracy without any effect of the through hole area.

The wire image 65 is outputted to the detection sensitivity setting part 46 and respective different defect detection sensitivities are set for the wire area 651 and the other area in the wire image 65 (Step S17). If necessary, a different defect detection sensitivity is also set for the fine wire removed area 641 of FIG. 7, and for example, three area threshold values (the minimum values in area of a defect to be detected) are set from the smallest one to the largest one for the wire area 651, the fine wire removed area 641 and the other area in this order. Actually, in each of the wire image (and the eroded and dilated image) corresponding to the resist area and that corresponding to the non-resist area, respective different defect detection sensitivities area set for the wire area 651, the fine wire removed area 641 and the other area.

As discussed above, the defect detection apparatus 1 executes Step S11 and Steps S12 to S17 of FIG. 2 in parallel. Specifically, the image pickup part 3 sequentially acquires values of pixels in the inspection color image while the defect detection sensitivities are set on the basis of the wire image 65 (and the eroded and dilated image 64) obtained from the reference color image. At this time, values of pixels in the reference binary image generated by the binary image generation part 43 are also sequentially outputted to the defect detection part 47 (in the reference binary image outputted to the defect detection part 47, however, the through hole areas have the same pixel value as the background portion has).

The defect detection part 47 generates the inspection binary image from an inspection color image and compares a value of each pixel in the inspection binary image with a value of the corresponding pixel in the reference binary image, to detect defect candidates. The inspection color image may be used as the inspection image without being binarized, and in this case, a differential image between the inspection color image and the reference color image is binarized, to detect defect candidates. An image which is obtained by performing a predetermined processing on the inspection color image may be used as the inspection image (the same applies to the following). Then, it is determined whether the defect candidate is a defect or not with selecting one of the different defect detection sensitivities. One of the different defect detection susitivities is selected with referring whether the position of the defect candidate is included in the resist area or the non-resist area and whether the position is included in the wire area 651, the fine wire removed area 641 or the other area. Thus, the defect detection part 47 detects a defect(s) in the inspection image in accordance with the defect detection sensitivities and outputs a signal R indicating the detection result (Step S18). Though the operation for acquiring the inspection color image and the operation for setting the defect detection sensitivities are performed in parallel in the above case, if the reference color image is acquired in advance by picking up an image of a substrate with no defect or the reference color image is generated on the basis of design data, for example, Steps S12 to S17 of FIG. 2 may be executed as preparation for pattern inspection.

Thus, in the defect detection apparatus 1 of FIG. 1, each of the binary image representing only the resist area and that representing only the non-resist area is generated as the reference binary image 61. Then, the erosion is performed on the specific areas 611 in the reference binary image 61 which has the same pixel value as that corresponding to the wire areas and thereafter, the dilation is performed to acquire the eroded and dilated image 63, and the wire image 65 is automatically generated on the basis of the eroded and dilated image 63 and the reference binary image 61. This avoids the operator's complicated work for setting areas and makes it possible to easily and appropriately extract the fine wire areas 651 which are fine pattern areas. In each of the resist area and the non-resist area, an inspection in accordance with the area is achieved with the defect detection sensitivity changed on the basis of the wire image 65, and it is therefore possible to appropriately detect a defect in a pattern on the substrate 9.

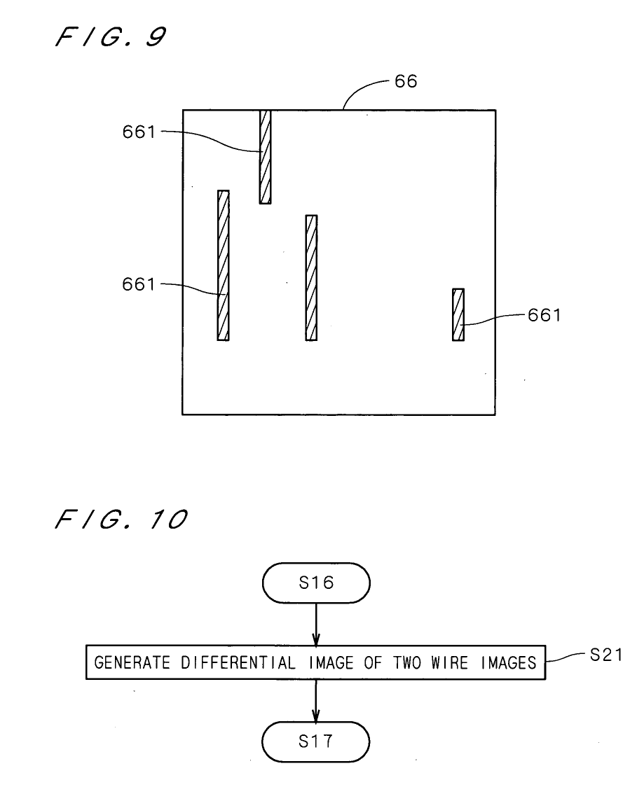

In the defect detection apparatus 1, the dilation may be performed on the wire areas 651 in the wire image 65 of FIG. 8 as necessary, to further acquire a wire image 66 after the dilation as shown in FIG. 9. The wire image 66 after the dilation represents areas 661 which correspond to areas including the vicinity of the fine wires 92 on the substrate 9 (the areas represented by reference numeral 921 in FIG. 3). By detecting defects in the inspection image in accordance with the defect detection sensitivities set on the basis of the wire image 66, it is possible to perform a detailed inspection on defects in the vicinity of the wires 92 among those present in the background portion on the substrate 9 with the same defect detection sensitivity as that for the wires 92 and perform a rough inspection on defects in the other area.

Next, discussion will be made on another exemplary procedure of the defect detection apparatus 1 for detecting a defect(s). FIG. 10 is a flowchart showing another exemplary operation flow for detecting a defect, and this operation is performed between Step S16 and Step S17 of FIG. 2. In this procedure, the specific wire area extraction part 48 of FIG. 1 is used.

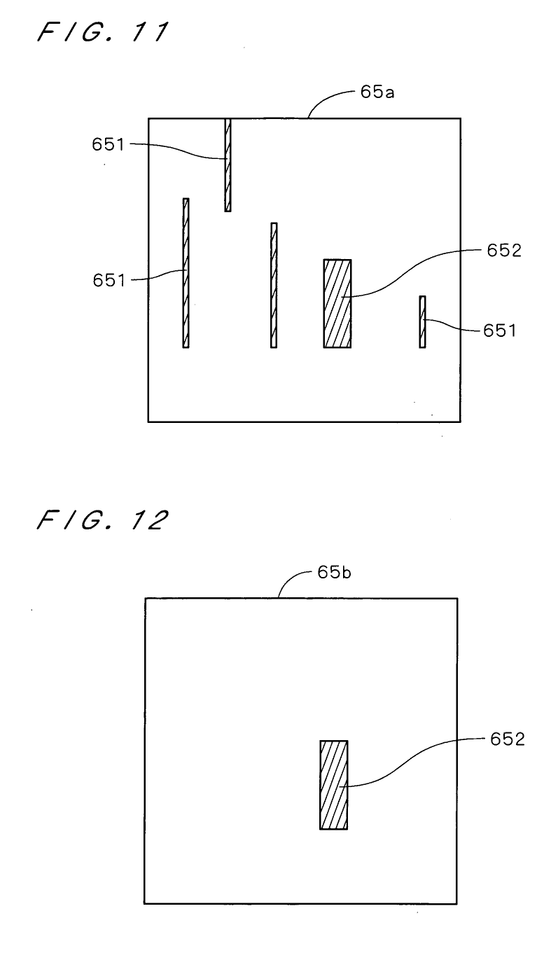

In another exemplary defect detection procedure, another wire image is generated as well as the above-discussed wire image 65. Specifically, in Step S14 of FIG. 2, an eroded image is acquired in an erosion with a degree of erosion higher than that in the above case. At this time, in the specific area of the eroded image, both the areas which correspond to the wires 92 on the substrate 9 and the area which corresponds to the wire 93 disappear (as eroded more than in the case of FIG. 5). Subsequently, a dilation is performed on the specific areas which remain in the eroded image to almost the same degree as this erosion, to thereby acquire an eroded and dilated image where no area corresponding to the wires 92 and 93 is present (an image in which a line extending upwards from the specific area 611 in the lower side of FIG. 6 disappears) (Step S15). Then, the eroded and dilated image and the reference binary image 61 are compared with each other, to acquire another wire image 65a as shown in FIG. 11 (Step S16). In the wire image 65a, the wire areas 651 which correspond to the wires 92 on the substrate 9 and a wire area 652 which corresponds to the wire 93 are present.

The specific wire area extraction part 48 generates a differential image between the two wire images 65 and 65a which are generated in the erosion and dilation part 44 and the wire area acquisition part 45 with the degree of erosion and dilation changed, to thereby acquire a wire image 65b representing only the wire area 652 having a specific width, which corresponds to the wire 93 on the substrate 9, as shown in FIG. 12 (Step S21). Then, on the basis of the wire images 65 and 65b, respective different defect detection sensitivities are set for the wire areas 651 corresponding to the wires 92 on the substrate 9, the wire area 652 corresponding to the wire 93 and the other area (Step S17), and detection of a defect in the inspection image is performed in accordance with the defect detection sensitivities (Step S18).

Thus, in another exemplary defect detection procedure, the specific wire area extraction part 48 acquires the wire area 652 which is a specific fine pattern area used in the detection sensitivity setting part 46. It is therefore possible to detect a defect with high accuracy with respective individual defect detection sensitivities set for the wire areas 651 and 652 having specific widths, which correspond to the wires 92 and 93 on the substrate 9, respectively. A dilation may be performed on the wire area 652 in the wire image 65b of FIG. 12, to acquire an image representing an area which corresponds to the area including the vicinity of the wire 93 on the substrate 9 (the area represented by reference numeral 931 in FIG. 3). In this case, the same defect detection sensitivity as that for the wire 93 is given to defects present in the vicinity of the wire 93 among defects present in the background portion on the substrate 9.

Next, discussion will be made on still another exemplary procedure of the defect detection apparatus 1 for detecting a defect(s). In this procedure, a wire image is generated on the basis of the inspection color image acquired by the image pickup part 3.

Specifically, as indicated by broken line in FIG. 1, the image pickup part 3 is further connected to the preprocessor 42, and the inspection color image acquired by the image pickup part 3 is outputted to the preprocessor 42 and the defect detection part 47 (Step S11 of FIG. 2). Then, the resist area corresponding to the area on the substrate 9 which is coated with the resist, the non-resist area and the through hole areas corresponding to the through holes 94 are acquired from the inspection color image (Step S12), and the binary image generation part 43 generates the binary image representing only the resist area and the binary image representing only the non-resist area as inspection binary images (Step S13). In the following discussion, it is assumed that one inspection binary image obtained by uniting the two binary images is used.

FIG. 13 is a view showing an inspection binary image 67 generated from the inspection color image. In some cases, there are very small unnecessary substances in the background portion on an actually-inspected substrate 9. In the generated inspection binary image 67, areas 671a which correspond to unnecessary substances are regarded to have the same pixel value as that in the area which corresponds to the conductive portion on the substrate 9 and in the following procedures, the conductive area, the through hole areas and the areas corresponding to the unnecessary substances are used as specific areas 671.

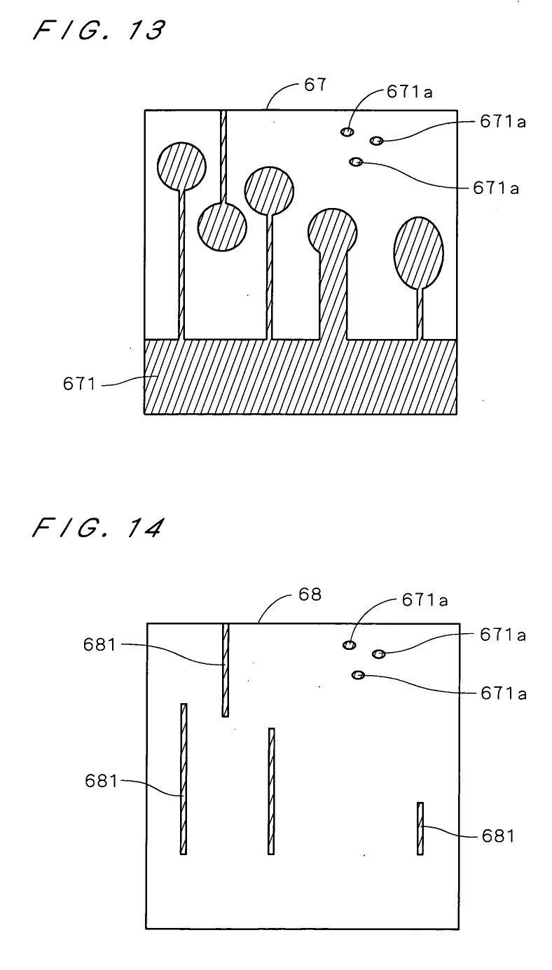

Subsequently, the erosion and the dilation are performed on the specific areas 671 in the inspection binary image 67, to thereby acquire an eroded and dilated image (Steps S14 and S15), and a differential image between the eroded and dilated image and the inspection binary image 67 is generated, to acquire an wire image 68 shown in FIG. 14 (Step S16). In the wire image 68 of FIG. 14, the areas 671a corresponding to the unnecessary substances remain as well as the specific areas 681.

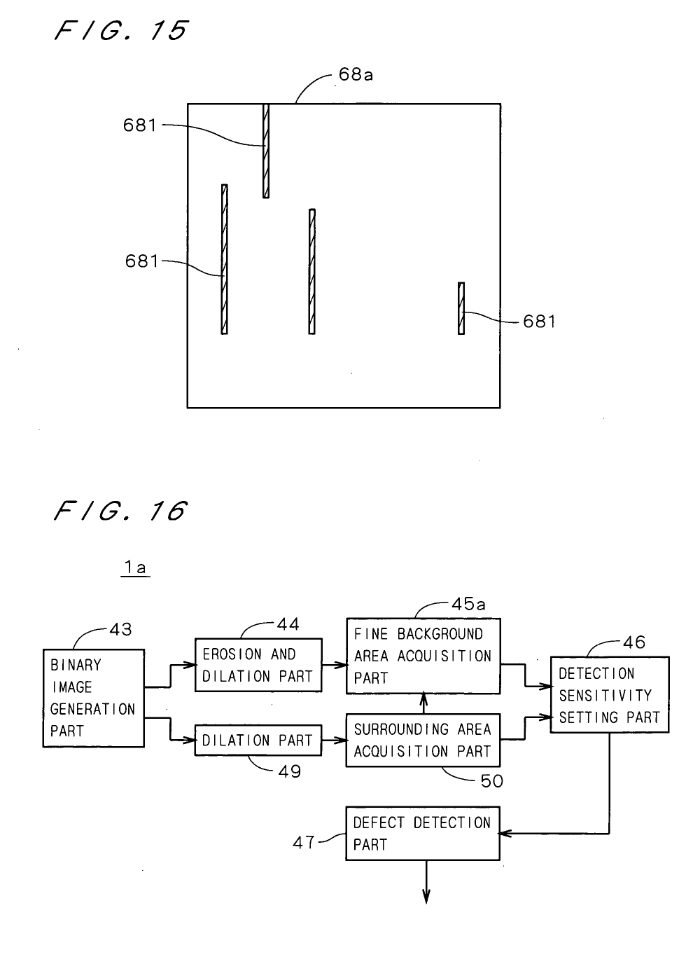

The wire area acquisition part 45 prepares the reference binary image after the dilation with a predetermined degree of dilation and obtains the logical product of a value of each pixel in the reference binary image and a value of the corresponding pixel in the wire image 68 by calculation, to thereby generate a wire image 68a having pixel values which are the calculation results as shown in FIG. 15. In other words, by masking the wire image 68 with the reference binary image after the dilation, the wire image 68 is corrected to obtain the corrected wire image 68a. Then, detection of a defect in the inspection image is performed in accordance with the defect detection sensitivities set on the basis of the wire image 68a (Steps S17 and S18).

Thus, in the still another exemplary defect detection procedure, by actually picking up an image of the substrate 9, the wire image 68 is obtained from the inspection binary image 67 on the basis of the acquired inspection color image. Then, the wire image 68 is corrected by using the reference binary image after the dilation and the defect detection sensitivities are set on the basis of the corrected wire image 68a. In the defect detection apparatus 1, since the wire image 68 is generated from the inspection binary image 67, even if there is a positional difference in a pattern due to deformation of the substrate 9 or the like, it is possible to set the defect detection sensitivities through extraction of areas in accordance with the actual pattern and detect a defect in consideration of positional difference in the pattern. With the reference binary image, it is further possible to remove a noise caused by the inspection binary image 67.

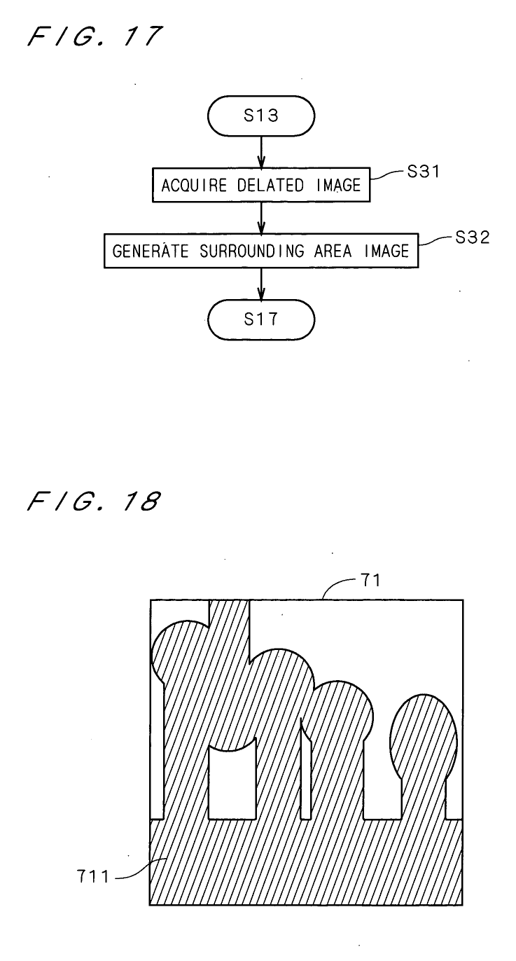

FIG. 16 is a view showing part of constitution of a defect detection apparatus 1a in accordance with the second preferred embodiment of the present invention. In the defect detection apparatus 1a of FIG. 16, as compared with the defect detection apparatus 1 of FIG. 1, the wire area acquisition part 45 is replaced by a fine background area acquisition part 45a and a dilation part 49 and a surrounding area acquisition part 50 are further provided between the binary image generation part 43 and the detection sensitivity setting part 46, in parallel with the erosion and dilation part 44 and the fine background area acquisition part 45a. Other constituent elements are identical to those in FIG. 1.

FIG. 17 is a flowchart showing an operation flow of the defect detection apparatus 1a for detecting a defect, and this operation is performed instead of Steps S14 to S16 of FIG. 2. The procedures other than those of FIG. 17 are the same as shown in FIG. 2. In the procedures of FIG. 17, an area which corresponds to an area around the conductive portion on the substrate 9 is extracted. Hereafter, this operation will be discussed, and the erosion and dilation part 44 and the fine background area acquisition part 45a in FIG. 16 are not used in this operation and an operation using these constituent elements will be discussed later.

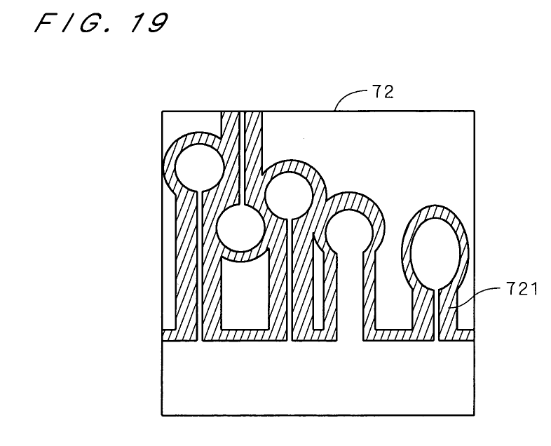

In the defect detection apparatus 1a, like in the first preferred embodiment, the reference binary image 61 shown in FIG. 4 is generated from the reference color image (Step S13 of FIG. 2). At this time, as discussed above, the same pixel value “1” is given to the conductive area and the through hole areas in the reference binary image 61. Subsequently, the dilation part 49 performs the dilation on the specific areas 611 in the reference binary image 61 which has the same pixel value “1” as the corresponding pixel value in the wire areas, to thereby acquire a dilated image 71 representing a specific area 711 after being dilated, as shown in FIG. 18 (Step S31). The degree of dilation is determined in advance in accordance with a range to be extracted, which are present around the conductive portion on the substrate 9.

The surrounding area acquisition part 50 generates a differential image between the dilated image 71 and the reference binary image 61 by obtaining the exclusive OR of a value of each pixel in the dilated image 71 and a value of the corresponding pixel in the reference binary image 61, to thereby acquire a surrounding area image 72 representing a surrounding area 721 of the specific areas 611 in the reference binary image 61 as shown in FIG. 19 (Step S32). Then, respective different defect detection sensitivities are set for the specific areas 611, the surrounding area 721 and the other areas in the reference binary image 61 on the basis of the reference binary image 61 and the surrounding area image 72 (Step S17 of FIG. 2), and detection of a defect in the inspection image acquired by the image pickup part 3 is performed in accordance with the defect detection sensitivities (Step S18).

Thus, in the defect detection apparatus 1a of FIG. 16, the surrounding area image 72 representing the surrounding area 721 of the specific areas 611 is acquired on the basis of the dilated image 71 which is obtained by dilating the specific areas 611 in the reference binary image 61 and the reference binary image 61. This avoids the operator's complicated work for setting areas and makes it possible to easily extract the surrounding area 721 in a certain range from the specific areas 611 in the reference binary image 61, and respective individual defect detection sensitivities are set for the two areas in the reference binary image 61 which correspond to an area near the conductive portion and an areas far away from the conductive portion in the background portion on the substrate 9. As a result, it is therefore possible to appropriately detect a defect in a pattern on the substrate 9.

Next, discussion will be made on another exemplary defect detection procedure in the defect detection apparatus 1a. In another exemplary defect detection procedure, the erosion and dilation part 44 and the fine background area acquisition part 45a of FIG. 16 are used and procedures in conformance with Steps S14 to S16 of FIG. 2 are executed in parallel with the procedures of FIG. 17. Hereafter, the procedures in conformance with Steps S14 to S16 of FIG. 2 will be discussed.

The erosion and dilation part 44 performs the erosion on a background area (the not-hatched area in FIG. 4) in the reference binary image 61 of FIG. 4 which has the pixel value “0” corresponding to a background, to thereby acquire an eroded image (Step S14 of FIG. 2). In other words, the background area is regarded as the above-discussed specific area. In this eroded image, an area corresponding to a narrow background portion, such as a gap between wires on the substrate 9, (hereinafter, referred to as “fine background area”) disappears. Subsequently, the dilation is performed on the background area which remains in the eroded image to almost the same degree as the erosion, to thereby acquire an eroded and dilated image in which the fine background area disappears (Step S15). Then, the fine background area acquisition part 45a generates a differential image between the eroded and dilated image and the reference binary image 61, to thereby acquire a fine background image representing the fine background area, and further, the surrounding area image 72 acquired in Step S32 and the fine background image are compared with each other, to thereby separate the fine background area from the surrounding area 721 (Step S16).

The detection sensitivity setting part 46 sets a defect detection sensitivity for the fine background area which is different from that for the surrounding area (Step S117), and detection of a defect in the inspection image is performed in accordance with the defect detection sensitivity (Step S18). In the defect detection apparatus 1a, it is thereby possible to detect a defect in a pattern including wires formed on the substrate 9 with high accuracy, with the fine background area separated from the surrounding area 721.

Also in the defect detection apparatus 1a of FIG. 16, the surrounding area image and the fine background image may be generated on the basis of the inspection binary image which is a binary image obtained from the inspection color image acquired by the image pickup part 3. In this case, the surrounding area acquisition part 50 corrects the surrounding area image generated from the inspection binary image by masking the surrounding area image with the reference binary image after the dilation. By generating the surrounding area image form the inspection binary image, it is possible to perform a defect detection in consideration of a positional difference in the pattern, and by using the reference binary image after the dilation, it is further possible to remove a noise caused by the inspection binary image.

Though the preferred embodiments of the present invention have been discussed above, the present invention is not limited to the above-discussed preferred embodiments, but allows various variations.

In the first preferred embodiment, for example, there may be a case where the dilation is performed on the background area in the reference binary image 61 and then the erosion is performed thereon to thereby acquire a dilated and eroded image, and the wire image is generated on the basis of the dilated and eroded image. In other words, in the above-discussed preferred embodiment, performing the dilation on the specific area (including the wire area) in the inspection binary image or the reference binary image is equivalent to performing the erosion on the background area, and performing the erosion on the specific area is equivalent to performing the dilation on the background area.

With combination of the procedures of the first preferred embodiment and those of the second preferred embodiment, by acquiring the wire area, the surrounding area and the fine background area, it is possible to achieve a defect detection with higher accuracy.

If it is not necessary to perform the defect detection procedures at a high speed, the whole of, or part of functions of the constituent elements (except the image pickup part 3) for the defect detection procedures may be implemented by software. In the defect detection apparatus, the function of a wire area extraction apparatus for extracting a wire area from an object image may be used for purposes other than defect detection. The substrate 9 on which a pattern to be inspected by the defect detection apparatus is formed may be a wiring board (substrate) such as a semiconductor substrate and a glass substrate, as well as a printed circuit board.

While the invention has been shown and described in detail, the foregoing description is in all aspects illustrative and not restrictive. It is therefore understood that numerous modifications and variations can be devised without departing from the scope of the invention.

This application claims priority benefit under 35 U.S.C. Section 119 of Japanese Patent Application No. 2004-143794 in the Japanese Patent Office on May 13, 2004, the entire disclosure of which is incorporated herein by reference.

1. A defect detection apparatus for detecting a defect in a geometric pattern formed on a substrate, comprising:
an image pickup part for picking up an image of a substrate;
an erosion and dilation part for performing an erosion on a specific area having a specific pixel value in one image of an inspection binary image on the basis of an inspection image acquired by said image pickup part and a reference binary image to acquire an eroded image and performing a dilation on said specific area which remains in said eroded image to almost the same degree as said erosion to acquire an eroded and dilated image;
a fine pattern area acquisition part for generating a differential image between said eroded and dilated image and said one image as a fine pattern image representing a fine pattern area;
a detection sensitivity setting part for setting respective different defect detection sensitivities for said fine pattern area and other area; and
a defect detection part for detecting a defect in said inspection image in accordance with said defect detection sensitivities.

2. The defect detection apparatus according to claim 1, further comprising
a specific fine pattern area extraction part for acquiring a specific fine pattern area which is used in said detection sensitivity setting part by generating a differential image between two fine pattern images which are generated with the degree of erosion and dilation changed in said erosion and dilation part and said fine pattern area acquisition part.

3. The defect detection apparatus according to claim 1, wherein
said one image is said inspection binary image, and
said fine pattern area acquisition part corrects said fine pattern image by masking said fine pattern image with said reference binary image after said dilation.

4. The defect detection apparatus according to claim 1, wherein
said substrate is a wiring board and said specific area is an area in said inspection binary image which has the same pixel value as a pixel value corresponding to a wire area.

5. The defect detection apparatus according to claim 4, further comprising
a through hole area acquisition part for acquiring a through hole area corresponding to a through hole on said substrate from a color image acquired by said image pickup part or a reference color image,
wherein said fine pattern area acquisition part substantially regards an area on said substrate which corresponds to said through hole and a land portion for said through hole as a non-wire area on the basis of said through hole area.

6. The defect detection apparatus according to claim 4, further comprising
a resist area acquisition part for acquiring a resist area which corresponds to an area on said substrate which is coated with a resist, from a color image acquired by said image pickup part or a reference color image; and
a binary image generation part for generating a binary image representing only said resist area and a binary image representing only a non-resist area each as said one image.

7. A wire area extraction apparatus for extracting a wire area from an object image representing a geometric pattern including wires formed on a substrate, comprising:
an erosion and dilation part for performing an erosion on a specific area having the same pixel value as a pixel value corresponding to a wire area in an object image which is a binary image to acquire an eroded image and performing a dilation on said specific area which remains in said eroded image to almost the same degree as said erosion to acquire an eroded and dilated image; and
a wire area acquisition part for generating a differential image between said eroded and dilated image and said object image as a wire image representing a wire area.

8. The wire area extraction apparatus according to claim 7, further comprising
a specific wire area extraction part for acquiring a specific wire area by generating a differential image between two wire images which are generated with the degree of erosion and dilation changed in said erosion and dilation part and said wire area acquisition part.

9. The wire area extraction apparatus according to claim 7, further comprising
a through hole area acquisition part for acquiring a through hole area corresponding to a through hole on said substrate from a color image acquired by said image pickup part or a reference color image,
wherein said wire area acquisition part substantially regards an area on said substrate which corresponds to said through hole and a land portion for said through hole as a non-wire area on the basis of said through hole area.

10. The wire area extraction apparatus according to claim 7, further comprising
a resist area acquisition part for acquiring a resist area which corresponds to an area on said substrate which is coated with a resist, from a color image acquired by said image pickup part or a reference color image; and
a binary object image generation part for generating a binary image representing only said resist area and a binary image representing only a non-resist area each as said object image.

11. A defect detection apparatus for detecting a defect in a geometric pattern formed on a substrate, comprising:
an image pickup part for picking up an image of a substrate;
a dilation part for performing a dilation on a specific area having a specific pixel value in one image of an inspection binary image on the basis of an inspection image acquired by said image pickup part and a reference binary image to acquire a dilated image;
a surrounding area acquisition part for generating a differential image between said dilated image and said one image as a surrounding area image representing a surrounding area of said specific area;
a detection sensitivity setting part for setting respective different defect detection sensitivities for said surrounding area and other area; and
a defect detection part for detecting a defect in said inspection image in accordance with said defect detection sensitivities.

12. The defect detection apparatus according to claim 11, wherein
said one image is said inspection binary image, and
said surrounding area acquisition part corrects said surrounding area image by masking said surrounding area image with said reference binary image after said dilation.

13. The defect detection apparatus according to claim 11, wherein
said substrate is a wiring board and said specific area is an area in said inspection binary image which has the same pixel value as a pixel value corresponding to a wire area.

14. The defect detection apparatus according to claim 13, further comprising
an erosion and dilation part for performing an erosion on a background area having a pixel value corresponding to a background in one image of said inspection binary image and said reference binary image to acquire an eroded image and performing a dilation on said background area which remains in said eroded image to almost the same degree as said erosion to acquire an eroded and dilated image; and
a fine background area acquisition part for generating a differential image between said eroded and dilated image and said one image as a fine background image representing a fine background area to separate said fine background area from said surrounding area,
wherein said detection sensitivity setting part sets a defect detection sensitivity for said fine background area which is different from that for said surrounding area.

15. The defect detection apparatus according to claim 13, further comprising:
a resist area acquisition part for acquiring a resist area which corresponds to an area on said substrate which is coated with a resist, from a color image acquired by said image pickup part or a reference color image; and
a binary image generation part for generating a binary image representing only said resist area and a binary image representing only a non-resist area each as said one image.

16. A defect detection method for detecting a defect in a geometric pattern formed on a substrate, comprising the steps of:
a) picking up an image of a substrate;
b) performing an erosion on a specific area having a specific pixel value in one image of an inspection binary image on the basis of an inspection image acquired by image pickup and a reference binary image to acquire an eroded image;
c) performing a dilation on said specific area which remains in said eroded image to almost the same degree as said erosion to acquire an eroded and dilated image;
d) generating a differential image between said eroded and dilated image and said one image as a fine pattern image representing a fine pattern area;
e) setting respective different defect detection sensitivities for said fine pattern area and other area; and
f) detecting a defect in said inspection image in accordance with said defect detection sensitivities.

17. The defect detection method according to claim 16, wherein
two fine pattern images are generated with the degree of erosion and dilation changed in said step b) to said step d),
the defect detection method further comprising the step of
g) acquiring a specific fine pattern area which is used in said step e) by generating a differential image between said two fine pattern images.

18. The defect detection method according to claim 17, wherein
said one image is said inspection binary image, and
said fine pattern image is corrected by masking said fine pattern image with said reference binary image after said dilation in said step d).

19. The defect detection method according to claim 17, wherein
said substrate is a wiring board and said specific area is an area in said inspection binary image which has the same pixel value as a pixel value corresponding to a wire area.

20. The defect detection method according to claim 19, further comprising the step of
h) acquiring a through hole area corresponding to a through hole on a substrate from a color image acquired by picking up an image of said substrate or a reference color image,
wherein an area on said substrate which corresponds to said through hole and a land portion for said through hole is substantially regarded as a non-wire area on the basis of said through hole area in said step b) to said step d).

21. The defect detection method according to claim 19, further comprising the steps of:
i) acquiring a resist area which corresponds to an area on a substrate which is coated with a resist, from a color image acquired by picking up an image of said substrate or a reference color image; and
j) generating a binary image representing only said resist area and a binary image representing only a non-resist area each as said one image.

22. A wire area extraction method for extracting a wire area from an object image representing a geometric pattern including wires formed on a substrate, comprising the steps of:
a) performing an erosion on a specific area having the same pixel value as a pixel value corresponding to a wire area in an object image which is a binary image to acquire an eroded image;
b) performing a dilation on said specific area which remains in said eroded image to almost the same degree as said erosion to acquire an eroded and dilated image; and
c) generating a differential image between said eroded and dilated image and said object image as a wire image representing a wire area.

23. The wire area extraction method according to claim 22, wherein
two wire images are generated with the degree of erosion and dilation changed in said step a) to said step c),
the wire area extraction method further comprising the step of
d) acquiring a specific wire area by generating a differential image between said two wire images.

24. The wire area extraction method according to claim 22, further comprising the step of
e) acquiring a through hole area corresponding to a through hole on a substrate from a color image acquired by picking up an image of said substrate or a reference color image,
wherein an area on said substrate which corresponds to said through hole and a land portion for said through hole is substantially regarded as a non-wire area on the basis of said through hole area in said step a) to said step c).

25. The wire area extraction method according to claim 22, further comprising the steps of:
f) acquiring a resist area which corresponds to an area on a substrate which is coated with a resist, from a color image acquired by picking up an image of said substrate or a reference color image; and
g) generating a binary image representing only said resist area and a binary image representing only a non-resist area each as said object image.

26. A defect detection method for detecting a defect in a geometric pattern formed on a substrate, comprising the steps of:
a) picking up an image of a substrate;
b) performing a dilation on a specific area having a specific pixel value in one image of an inspection binary image on the basis of an inspection image acquired by image pickup and a reference binary image to acquire a dilated image;
c) generating a differential image between said dilated image and said one image as a surrounding area image representing a surrounding area of said specific area;
d) setting respective different defect detection sensitivities for said surrounding area and other area; and
e) detecting a defect in said inspection image in accordance with said defect detection sensitivities.

27. The defect detection method according to claim 26, wherein
said one image is said inspection binary image, and
said surrounding area image is corrected by masking said surrounding area image with said reference binary image after said dilation in said step c).

28. The defect detection method according to claim 26, wherein
said substrate is a wiring board and said specific area is an area in said inspection binary image which has the same pixel value as a pixel value corresponding to a wire area.

29. The defect detection method according to claim 28, further comprising the steps of:
f) performing an erosion on a background area having a pixel value corresponding to a background in one image of said inspection binary image and said reference binary image to acquire an eroded image and performing a dilation on said background area which remains in said eroded image to almost the same degree as said erosion to acquire an eroded and dilated image; and
g) generating a differential image between said eroded and dilated image and said one image as a fine background image representing a fine background area to separate said fine background area from said surrounding area,
wherein a defect detection sensitivity for said fine background area which is different from that for said surrounding area is set in said step d).

30. The defect detection method according to claim 28, further comprising the steps of:
h) acquiring a resist area which corresponds to an area on a substrate which is coated with a resist, from a color image acquired by picking up an image of said substrate or a reference color image; and
i) generating a binary image representing only said resist area and a binary image representing only a non-resist area each as said one image.
